(19) United States
(12) Patent Application Publication
(10) Pub. No.: US 2025/0100094 A1
(43) Pub. Date: Mar. 27, 2025

(54) CLAMPING DEVICE, PARTICULARLY FOR A WORKPIECE CARRIER FOR A CABLE

(71) Applicant: MD Elektronik GmbH, Waldkraiburg (DE)

(72) Inventor: Benedikt STRAUSS, Mittergars (DE)

(21) Appl. No.: 18/826,214

(22) Filed: Sep. 6, 2024

(30) Foreign Application Priority Data
Sep. 25, 2023 (DE) 10 2023 125 839.7

(51) Int. Cl. B23Q 3/06; B23Q 3/10; H01B 13/00

(52) U.S. Cl. CPC B23Q 3/064; B23Q 3/102; B23Q 2703/10; B23Q 2703/12; H01B 13/00

(57) ABSTRACT

A clamping device includes an actuatable actuator with two actuator halves, each having a clamping jaw disposed thereon. When the actuator is actuated, a cable can be releasably clamped between receiving contours of the clamping jaws. At least one clamping jaw is formed in two parts and has a base part attached to the respective actuator half and an interchangeable part disposed on the base part. The interchangeable part has a support section with a support surface resting on the base part and a contact section resting against the base part. The respective receiving contour is formed on the contact section on an outer side facing the other clamping jaw. A contact surface formed on the contact section on an inner side facing away from the other clamping jaw rests against a contact surface of the base part, and forms an acute angle with the support surface.

### CROSS REFERENCE TO RELATED APPLICATIONS

This application claims benefit to German Patent Application No. DE 10 2023 125 839.7, filed on Sep. 25, 2023, which is hereby incorporated by reference herein.

### FIELD

The invention relates to a clamping device, particularly a workpiece carrier for a cable, and to a workpiece carrier with such a clamping device.

### BACKGROUND

It is known from the cable processing practice to hold a cable, particularly a stripped cable end, clamped and releasably fixed in a clamping device for processing the cable. In particular, it is known to fix the cable in a workpiece carrier in such a way that the two ends of the cable are each held clamped and releasably fixed in a clamping device, whereby the cable is held in the workpiece carrier in a U-shape or in several superimposed windings as a so-called coil.

It is known to provide a clamping device for a cable, which has an actuatable actuator with two actuator halves, whereby one of two clamping jaws is disposed on the respective actuator half. When the actuator is actuated, the clamping jaws move toward each other and clamp a section of the cable to be processed between the clamping jaws. If the actuator is actuated again, the tension of the clamping jaws is removed or reduced so that the clamped cable can be released and removed. Each of the two clamping jaws has a receiving contour on a side surface facing the other clamping jaw, which is configured, for example, as a circular arc shaped longitudinal groove, whereby a section of the sheath surface of the cable can be received in a clamped state in the longitudinal groove when the actuator is actuated, i.e. when the clamping jaws are moved relative to each other.

The receiving contour of the respective clamping jaw can be matched to the cable to be held clamped, for example, in the case of a longitudinal groove with a circular cross-section profile, the radius of the circular arc of the profile can be matched to the diameter of the sheath surface of the cable. If cables with a different diameter are to be processed, the clamping jaw would have to be replaced.

It is known to fasten the clamping jaw to the actuator half by means of an additional fastener, for example a screw. If the clamping jaw is to be replaced, an additional tool, such as a screwdriver, is required to loosen the tightened screw, after which the clamping jaw can be replaced with a new clamping jaw. The new clamping jaw must then be tightened again with the tool, for example the screwdriver.

In an automated cable processing plant, many cables are processed simultaneously, whereby each cable can be clamped in a workpiece carrier, which in turn can have two clamping devices with two clamping jaws each. Replacing all the clamping jaws using an additional tool to loosen a fastener such as a screw and then tighten it again later after replacing the clamping jaw can be laborious, especially as loosening and retightening the fastener requires a human operator and is difficult to automate.

With reference to FIG. 5, DE 10 2004 061 047 B3 describes a clamping device with two clamping jaws which grip a cable end to be processed, the respective clamping jaw being fastened to one of two actuator halves by means of a screw. If a clamping jaw is to be replaced, the at least one screw would have to be loosened using an additional tool and, after replacing the clamping jaw, tightened again in order to fasten the new clamping jaw.

EP 0 993 085 A2 describes a clamping device for receiving a cable with two clamping jaws that are pivotable towards each other, whereby the respective clamping jaw has a circular arc shaped cross-sectional contour in sections, which receives the cable along a circumferential section. The pivot axis of the respective clamping jaw is aligned essentially parallel to the longitudinal direction of the cable. If a clamping jaw is to be replaced, the clamping jaw must be removed from the pivot arm and a new clamping jaw mounted on the pivot arm. It would also be possible to replace the pivot arm with the clamping jaw attached to it. In both cases, a tool would be required, which makes replacement laborious.

US 2022/0305621 A1 describes a fixed bench vise for clamping a workpiece that has essentially flat side surfaces. The vise has two jaws, each of which is fastened to a carrier block, the respective carrier block being penetrated by a thread section of a thread-driven spindle. The respective jaw is held on the respective carrier block by a tongue and groove guide, for interaction of surface sections of the jaw and the carrier block that are approximately perpendicular to each other. Replacing the jaw of the fixed vise is possible only laboriously when the thread sections are removed and is intended, for the normal functioning of the vise, only in the event of a repair.

### SUMMARY

In an embodiment, the invention provides a clamping device, particularly for a workpiece carrier for a cable. The clamping device includes an actuatable actuator with two actuator halves, a first clamping jaw, which is disposed on a first actuator half of the two actuator halves, and a second clamping jaw, which is disposed on a second actuator half of the two actuator halves. When the actuator is actuated, the cable can be releasably clamped in sections between a receiving contour of the first clamping jaw and a receiving contour of the second clamping jaw. At least one of the clamping jaws is formed in two parts and has a base part attached to the respective actuator half and an interchangeable part disposed on the base part. The interchangeable part has a support section with a support surface resting on the base part and a contact section resting against the base part. The respective receiving contour is formed on the contact section on an outer side facing the other clamping jaw. A contact surface is formed on the contact section on an inner side facing away from the other clamping jaw, with which the contact section rests against a contact surface of the base part. The contact surface of the contact section of the interchangeable part forms an acute angle with the support surface of the interchangeable part resting on the base part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a partially sectioned view of an exemplary embodiment of a clamping device according to the invention;

FIG. 2 shows a partially sectioned view of the clamping device from FIG. 1, from a different perspective;

FIG. 3 shows a perspective view of the clamping device from FIG. 1 and FIG. 2 in an incompletely mounted position; and

FIG. 4 shows a perspective view of the interchangeable part of the clamping device from FIG. 1 to FIG. 3.

### DETAILED DESCRIPTION

Embodiments of the invention to provide a possibility for simple and quick changing of a clamping jaw for a clamping device, particularly also for a workpiece carrier with a clamping device.

According to an embodiment of the invention, the possibility for simple and quick changing of a clamping jaw is achieved by a clamping device, in particular for a workpiece carrier for a cable, wherein the clamping device has:
an actuatable actuator with two actuator halves,
a first clamping jaw, which is disposed on the first actuator half, and a second clamping jaw, which is disposed on the second actuator half, wherein, when the actuator is actuated, the cable can be releasably clamped in sections between a receiving contour of the first clamping jaw and a receiving contour of the second clamping jaw,
wherein at least one clamping jaw is formed in two parts and has a base part attached to the actuator half and an interchangeable part disposed on the base part,
wherein the interchangeable part has a support section with a support surface resting on the base part and a contact section resting against the base part,
whereby the receiving contour is formed on the contact section on the outer side facing towards the other clamping jaw,
wherein on the contact section on an inner side facing away from the other clamping jaw a contact surface is formed with which the contact section rests against a contact surface of the base part, and
whereby the contact surface of the contact section of the interchangeable part forms an acute angle with the support surface of the interchangeable part resting on the base part.

The two-part configuration of the at least one clamping jaw with a base part and an interchangeable part makes it possible to replace only the interchangeable part on which the receiving contour is formed in order to match the clamping jaw to a cable having a different diameter, for example. The interchangeable part rests on and/or against the base part in sections and can be easily replaced without the use of tools.

The support section of the interchangeable part, which rests loosely on the base part, and the contact section of the interchangeable part, which rests loosely against the base part, allow the interchangeable part to be replaced without having to loosen and refasten additional fastening means. In particular, a tool-free replacement of the interchangeable part relative to the base part attached to the actuator half is made possible.

The formation of the acute angle between the contact surface of the contact section of the interchangeable part and the support surface of the interchangeable part resting on the base part forms a guide pair of wedge surfaces which, when the cable section received in the receiving contour is pressed in the direction of the two-part clamping jaw when the actuator is actuated, causes the support section to be pressed onto the base part. This effect occurs in particular when the angle is significantly less than 90° and significantly greater than 0°.

In another embodiment, the possibility for simple and quick changing of the clamping jaw is achieved in particular for a workpiece carrier, in particular for a workpiece carrier for a cable, the workpiece carrier being configured for the clamped reception of the two cable ends of a cable, provided that the workpiece carrier has a clamping device according to an embodiment of the invention and/or comprises it as a component, in particular also in the case where each of the two clamping devices of the workpiece carrier for, in particular, each of the two cable ends is formed according to an embodiment of the invention.

Preferably, it is provided that the acute angle is approx. 30° to approx. 75°, in particular approx. 65°. This acute angle is also formed between the surface section of the base part, on which the support section of the interchangeable part rests, and the contact surface of the base part, against which the inner side of the contact section of the interchangeable part rests, so that the base part and the interchangeable part are in planar contact at two pairs of contacting surfaces that are tilted relative to each other by the acute angle when the actuator is actuated and the cable is thereby releasably clamped.

Preferably it is particularly provided for the interchangeable part to have two opposing cheek sections, with the respective cheek section resting closely against a side edge of the base part. The two cheek sections suppress undesired movement of the interchangeable part relative to the base part when the actuator is actuated and a force is exerted on the at least one two-part clamping jaw.

Preferably it is further provided that the interchangeable part is formed as a one-piece metallic molded part. This molded part is placed on and/or against the base part attached to the actuator half and/or can be removed from the base part again without the need for tools.

Preferably, the interchangeable part is made of a magnetically conductive material, and a permanent magnetization is provided in the base part, the magnetic circuit of which is closed by the magnetically conductive material of the interchangeable part. The permanent magnetization in the base part can be provided by a permanent magnet which is accommodated in the base part. The magnetic circuit reduces undesired relative movement of the interchangeable part relative to the base part in a direction parallel to the cable and/or in a direction away from the opposite clamping jaw.

Regarding the reduction of an undesired relative movement of the interchangeable part to the base part in the direction of the opposite clamping jaw, it can preferably be provided that the interchangeable part has a retaining section on an end section opposite the contact section, which overlaps an end edge of the base part in sections.

Preferably, it is provided that the base part has a fastening section for fastening to the actuator half, and whereby the fastening section is disposed outside the section of the base part covered by the interchangeable part. In particular, the base part can be L-shaped, with one leg of the L being covered by the interchangeable part, i.e. forming as large an uninterrupted surface of contact as possible with the interchangeable part, and the other leg of the L being configured as the fastening section of the base part, so that the base part is fastened to the actuator half in the region of the fastening section, for example by means of a screw connection.

Regarding a common contacting surface as large as possible between the support section of the interchangeable part and the base part, it is preferably provided for the interchangeable part to have an undercut in the region of the transition from the support surface of the support section to the contact surface of the contact section, which undercut extends essentially parallel to the receiving contour. An edge of the base part, which is formed in cross-section with the acute angle, can engage in the undercut.

Preferably, regarding the two clamping jaws of the clamping device, it is further provided that each of the two clamping jaws is formed in two parts, each with a base part and an interchangeable part, wherein the base part and/or the interchangeable part for the respective one of the two clamping jaws is configured, as described above, for at least one of the two clamping jaws.

Exemplary embodiments of the invention are described and explained in more detail below with reference to the accompanying drawings.

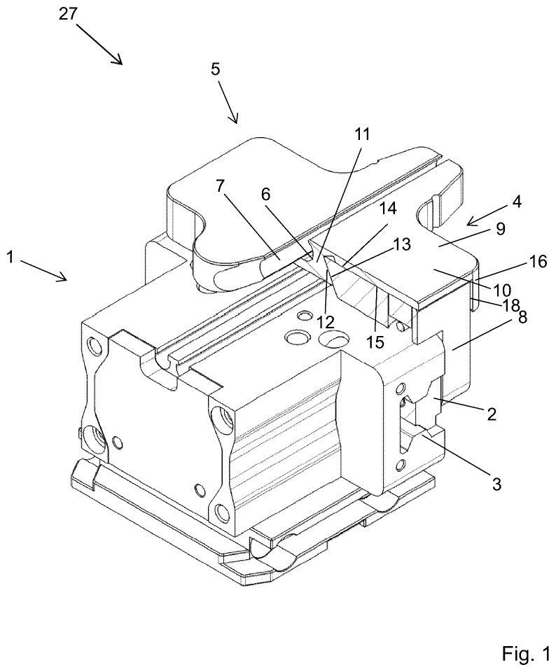

FIG. 1 shows an exemplary embodiment of a clamping device for a cable according to the invention, in a partially sectioned perspective view from a first viewing direction.

The clamping device comprises an actuator 1 with a first actuator half 2 and a second actuator half. The respective actuator half is slidably guided in a guide in the actuator housing, whereby the first actuator half 2 is slidably disposed in the guide 3 in the actuator housing. The second actuator half is not visible in the illustration in FIG. 1. The clamping device further has a first clamping jaw 4, which is disposed on the first actuator half 2, and a second clamping jaw 5, which is disposed on the second actuator half. During its actuation, the actuator 1 is configured to clamp a cable in sections between a receiving contour 6 of the first clamping jaw 4 and a receiving contour 7 of the second clamping jaw 5, and wherein the clamping is releasable when the actuation of the actuator 1 is removed so that the cable is released and can be removed.

The actuator 1 is configured in particular as a pneumatic actuator, during the actuation of which the two actuator halves 2 are moved towards each other and they clamp the cable in sections between the actuator halves 2. If the actuation of the pneumatic actuator 1 is removed, particularly if the pneumatic actuator 1 is depressurized, the two actuator halves 2 remain braced towards each other under the pre-tension of a mechanical spring. Against the low pre-tension of the mechanical spring, the cable clamped in sections can be removed when the clamping jaws 4, 5 are pressed away from each other, for example when the actuator 1 is pneumatically pressurized again.

It can be seen from FIG. 1 that at least one clamping jaw, namely at least the first clamping jaw 4, is formed in two parts, i.e. has two components that are independent from each other. The first clamping jaw 4 has a base part 8 attached to the first actuator half 2 and an interchangeable part 9 disposed on the base part 8, namely resting on the base part 8. The interchangeable part 9 is configured to be removable from the base part 8 and replaceable.

The interchangeable part 9 has a support section 10 resting on the base part 8 having a support surface 14 with which the support section 10 rests on the base part 8. The interchangeable part 9 also has a contact section 11 abutting the base part 8.

The receiving contour 6 is formed on the contact section 11 of the interchangeable part 9 on the outside facing the other, second clamping jaw 5, whereby a section of the circumference of the cable can be received in the receiving contour 6 in sections along the longitudinal direction of the cable in an approximately form-fitting manner.

A contact surface 12 is formed on the contact section 11 of the interchangeable part 9 on the inner side opposite the outer side and facing away from the other, second clamping jaw 5. In the illustration in FIG. 1, the contact surface 12 of the contact section 11 of the interchangeable part 9 rests laterally against a contact surface 13 of the base part 8.

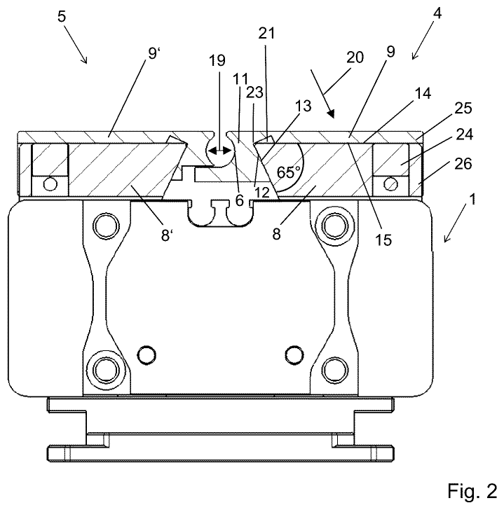

The contact surface 12 of the contact section 11 of the interchangeable part 9 forms an acute angle with the support surface 14 of the interchangeable part 9 resting on the base part 8, i.e. an angle that is significantly less than 90° and significantly greater than 0°. In the illustrated exemplary embodiment, the acute angle is approx. 30° to approx. 75°, particularly approx. 65° (FIG. 2).

Accordingly, the contact surface 13 of the base part 8 also forms the same acute angle with the support surface 15 of the base part 8, on which the support surface 14 of the support section 10 of the interchangeable part 9 rests.

The interacting support surfaces 14, 15 of the interchangeable part 9 and/or the base part 8 each have a flat configuration. The interacting contact surfaces 12, 13 of the base part 8 and/or the interchangeable part 9 also have a flat configuration and extend into the plane of the paper in the illustration in FIG. 1. Thereby the contact surface 12, 13 is inclined at an acute angle of approx. 30° to approx. 75°, particularly approx. 65°, relative to the corresponding support surface 14, 15.

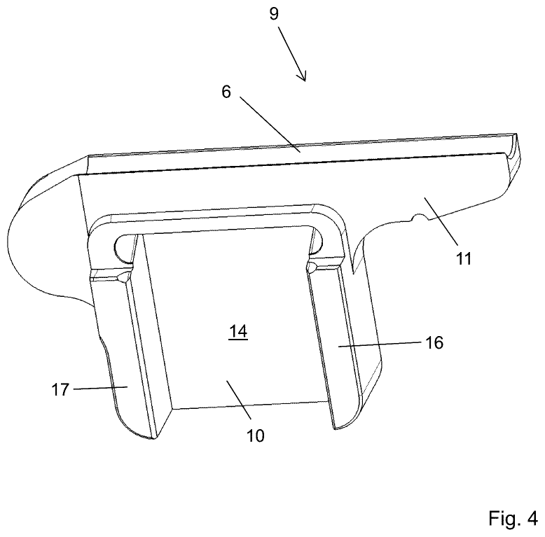

The interchangeable part 9 has two opposing cheek sections 16, 17, one of which is identified in FIG. 1 with the reference number “16”, and both of which are recognizable in the perspective view of FIG. 4. The respective cheek section, particularly the cheek section 16 in FIG. 1, rests closely against a side edge 18 of the base part 8, thus leaving only a small air gap to the surface of the side edge 18. The two cheek sections prevent a sliding of the interchangeable part 9 in the direction of the extent of the cable and/or in the direction of the extent of the receiving contour 6.

FIG. 2 shows the first clamping jaw 4 from FIG. 1 in a sectional view, from a viewing direction along the longitudinal extent of the cable.

If a cable were clamped between the clamping jaws 4, 5 and the actuator 1 were actuated, the cable would exert a force on the first clamping jaw 4 in accordance with the right partial arrow of the double arrow 19 on the receiving contour 6 of the interchangeable part 9. When this force is applied, the two contact surfaces 12, 13 act together as a wedge surface pairing, so that an imaginary resulting counterforce is created according to arrow 20, i.e. a resulting force with a high force component perpendicular to the two support surfaces 14, 15 with the effect that the interchangeable part 9 is pressed onto the base part 8 and is additionally fixed to the base part 8. The direction of the arrow 20 corresponds, offset essentially parallel, to the direction of the two contact surfaces 12, 13.

FIG. 2 further shows for the second clamping jaw 5 that the second clamping jaw 5 is also formed in two parts, with a base part 8′ and an interchangeable part 9′. In particular, it can be seen that each of the two clamping jaws 4, 5 is formed in two parts, each with a base part 8, 8′ and an interchangeable part 9, 9′, with the understanding that the previous description and the following description of the first clamping jaw 4 with the base part 8 and the interchangeable part 9 also apply analogously to the other, second clamping jaw 5.

As can be seen in FIG. 2 for the first clamping jaw 4, the same therefore also applies to the second clamping jaw 5 in that the interchangeable part 9 of the first clamping jaw 4 has an undercut 21 in the region of the transition from the support surface 14 of the support section 10 to the contact surface 12 of the contact section 11, which undercut extends essentially parallel to the receiving contour 6. It can further be seen that the contact section 11 of the interchangeable part 9 is formed such that it is positioned essentially vertically relative to the support section 10, such that the contact section 11 is disposed between the base part 8 and the opposing clamping jaw 5.

As explained above, it is provided that interchangeable part 9 is disposed and held, without any further additional fastening means, resting on the base part 8 in the region of the support section 10 and resting against the base part 8 in the region of the contact section 11, in particular the interchangeable part 9 can be removed and replaced without having to loosen any fastening means such as screws or the like and tighten them again after the replacement of the interchangeable part 9.

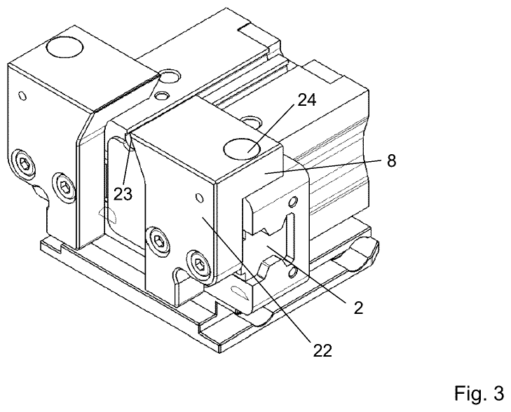

FIG. 3 shows a perspective view of the clamping device, in which the two interchangeable parts 9, 9′ from FIGS. 1 and 2 are removed, so that only the respective actuator half, in particular the first actuator half 2 and the base part 8 attached to the first actuator half 2 are visible. It can be seen that the base part 8 is essentially L-shaped, with the interchangeable part resting on one of the legs of the L with the other leg of the L being used for fastening to the actuator half 2. With this other leg of the L, the base part 8 has a fastening section 22 for fastening the base part 8 to the first actuator half 2, in particular two fastening screws for permanently fixing the base part 8 to the first actuator half 2 are recognizable. As a comparison with the illustration in FIG. 1 shows, this fastening section 22 is disposed outside the section of the base part 8 covered by the interchangeable part 9.

FIG. 4 shows a perspective view of the interchangeable part 9 from FIGS. 1 and 2. The interchangeable part 9 is configured as an exchangeable part of the clamping device and can be exchanged for another interchangeable part which, for example, has a different profile of the receiving contour 6, for example if cables with a different diameter or circumferential profile have to be received in the clamping device. The longitudinal extent of the receiving contour 6 can also differ for different interchangeable parts. FIG. 4 shows in particular a top view of the flat support surface 14 of the support section 10 of the interchangeable part 9.

FIG. 4 shows that the interchangeable part 9 is formed as a one-piece molded part, in particular as a molded part made of a metal. In particular, the interchangeable part 9 is formed as a milled part made of a hardened steel, especially a plasma-nitrided nitriding steel. Also the base part 8 in FIGS. 1 to 3 is formed as a one-piece, essentially L-shaped, molded part, in particular also made of a hardened steel, in particular a plasma-nitrided nitriding steel.

For the interchangeable part 9 it can be seen from FIG. 4 that the body of the interchangeable part 9 is continuous, i.e. it does not have an opening passing through the body from the outside to the inside through which a fastening means, such as a screw, would have to be passed.

For mounting the interchangeable part 9 on the base part 8, it is intended that the interchangeable part 9 from FIG. 4 is provided and disposed on the base part 8 from FIG. 3, which is permanently fixed on the first actuator half 2, in such a way that the base part 8 is accommodated between the cheek sections 16, 17 of the interchangeable part 9 in such a way that the contact section 11 of the interchangeable part 9 overlaps an edge 23 in such a way that the contact surface 12 of the contact section 11 of the interchangeable part 9 rests laterally against the contact surface 13 of the base part 8 (FIGS. 1, 2). In this position, a slight slidability of the interchangeable part 9 relative to the base part 8 towards the opposite clamping jaw would still be permitted (in the illustration in FIG. 2 from left to right or from right to left).

If the actuator 1 is actuated and the first clamping jaw 4 is moved toward the second clamping jaw 5 so that a cable is clamped between the clamping jaws 4, 5, the interchangeable part 9 is pressed onto the base part 8, as explained with reference to FIG. 2, so that a removable additional fixing of the interchangeable part 9 on the base part 8 occurs. If the actuator is depressurized, the interchangeable part 9 can be removed by lifting the contact section 11 of the interchangeable part 9 over the edge 23 of the base part 8 and by removing the interchangeable part 9 as a whole from the base part 8. For this removal, it may be necessary to press the two clamping jaws 4, 5 slightly away from each other, for example by actuating the pneumatic actuator 1 accordingly.

The slidability of the interchangeable part 9 relative to the base part 8, as long as no cable is clamped between the clamping jaws 4, 5, can be reduced, for example, by the fact that the interchangeable part 9 is formed of a magnetically conductive material and that a permanent magnetization is provided in the base part 8, the magnetic circuit of which is closed by the magnetically conductive material of the interchangeable part 9. In the exemplary embodiment shown, both the base part 8 and the interchangeable part 9 are made of a magnetically conductive material, namely the hardened steel and/or the plasma-nitrided steel. The permanent magnetization in the base part 8 is provided by a permanent magnet 24 (FIG. 2, 3) which is accommodated in a drill hole in the base part 8 in such a way that the permanent magnet 24 does not protrude beyond the support surface 15 of the base part 8.

Alternatively or additionally to a permanent magnetization in the base part 8, in particular a permanent magnet, it may be provided that the interchangeable part 9 has a retaining section on an end section 25 opposite the contact section 11, which retaining section overlaps an end edge 26 of the base part 8 in sections. The retaining section can, for example, be formed as an angled tab of the interchangeable part 9 at its end section 25, or as an additional part, for example an injection-molding made of an resilient plastic. The angled tab of the interchangeable part 9 can, for example, be manufactured as a milled part during the manufacture of the interchangeable part 9 by not removing the material in the region of the tab.

The clamping device 27 described above is configured to receive an electrical, optical or electro-optical cable between the clamping jaws 4, 5, each of which clamping jaws is formed in two parts, and to hold it releasably clamped between the clamping jaws 4, 5 when the actuator 1 is actuated. To accommodate the cable in sections, the receiving contour 6, 7 of the respective clamping jaw 4, 5 extends in the longitudinal direction of the cable by a multiple of the diameter of the cable. In particular, the receiving contour 6, 7 of the respective clamping jaw 4, 5 extends in the longitudinal direction well beyond the intermediate region provided directly between the base parts 8, 8′ of the clamping jaws 4, 5. The clamping device 27 is part of a workpiece carrier, which is configured in particular for receiving a cable, the workpiece carrier having a clamping device 27 for receiving each of the two ends of the cable.

Alternatively, the described clamping device 27 could also be disposed on a gripper, for example on an arm of a robot.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 actuator
2 first actuator half
3 guide of the first actuator half 2 in the actuator housing
4 first clamping jaw
5 second clamping jaw
6 receiving contour of the first clamping jaw 4
7 receiving contour of the second clamping jaw 5
8 base part of the first clamping jaw 4
8′ base part of the second clamping jaw 5
9 interchangeable part of the first clamping jaw 4
9′ interchangeable part of the second clamping jaw 5
10 support section of the interchangeable part 9
11 contact section of the interchangeable part 9
12 contact surface of the contact section 11
13 contact surface of the base part 8
14 support surface of the support section 10 of the interchangeable part 9
15 support surface of the base part 8
16 cheek section of the interchangeable part 9
17 cheek section of the interchangeable part 9
18 side edge of the base part 8
19 double arrow
20 arrow
21 undercut
22 fastening section of the base part 8
23 edge of the base part
24 permanent magnet
25 end section of the interchangeable part 9
26 end edge of the base part 8
27 clamping device

What is claimed is:

1. A clamping device, comprising:
an actuatable actuator with two actuator halves;
a first clamping jaw, which is disposed on a first actuator half of the two actuator halves; and
a second clamping jaw, which is disposed on a second actuator half of the two actuator halves, wherein, when the actuator is actuated, a cable can be releasably clamped in sections between a receiving contour of the first clamping jaw and a receiving contour of the second clamping jaw,
wherein at least one of the clamping jaws is formed in two parts and has a base part attached to the respective actuator half and an interchangeable part disposed on the base part,
wherein the interchangeable part has a support section with a support surface resting on the base part and a contact section resting against the base part,
wherein the respective receiving contour is formed on the contact section on an outer side facing the other clamping jaw,
wherein a contact surface is formed on the contact section on an inner side facing away from the other clamping jaw, with which the contact section rests against a contact surface of the base part, and
wherein the contact surface of the contact section of the interchangeable part forms an acute angle with the support surface of the interchangeable part resting on the base part.

2. The clamping device according to claim 1, wherein the acute angle is approximately 30° to approximately 75°.

3. The clamping device according to claim 1, wherein the acute angle is approximately 65°.

4. The clamping device according to claim 1, wherein the interchangeable part has two opposite cheek sections that rest closely against respective side edges of the base part.

5. The clamping device according to claim 1, wherein the interchangeable part is formed as a one-piece metallic molded part.

6. The clamping device according to claim 1, wherein the interchangeable part is formed from a magnetically conductive material, and wherein a permanent magnetization is provided in the base part, a magnetic circuit of which is closed by the magnetically conductive material of the interchangeable part.

7. The clamping device according to claim 1, wherein the interchangeable part has an undercut in a region of transition from the support surface of the support section to the contact surface of the contact section, the undercut extending essentially parallel to the receiving contour.

8. The clamping device according to claim 1, wherein the interchangeable part is disposed and held resting on the base part in a region of the support section and resting against a region of the contact section without further additional fastening means.

9. The clamping device according to claim 1, wherein the interchangeable part has a retaining section at an end section opposite the contact section, the retaining section overlapping an end edge of the base part in sections.

10. The clamping device according to claim 1, wherein the base part has a fastening section configured to be fastened to the respective actuator half, and wherein the fastening section is arranged outside a section of the base part covered by the interchangeable part.

11. The clamping device according to claim 1, wherein each of the first and second clamping jaws is formed in two parts with a respective base part and a respective interchangeable part.

12. The clamping device according to claim 1, wherein the clamping device is connected or connectable to a workpiece carrier for the cable.

13. A workpiece carrier, configured for clamped reception of two cable ends of a cable, comprising the clamping device according to claim 1.

14. The workpiece carrier according to claim 13, further comprising two of the clamping devices for the two cable ends.
